(19) United States
(12) Patent Application Publication
(10) Pub. No.: US 2003/0037171 A1
(43) Pub. Date: Feb. 20, 2003

(54) System and method for distributed device control

(76) Inventors: Kedar Madineni, Goleta, CA (US); Koral Ilgun, Santa Barbara, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/931,790

(22) Filed: Aug. 16, 2001

(51) Int. Cl. G06F 9/00

(52) U.S. Cl. 709/310

(57) ABSTRACT

System and method for distributed device control. The method may be implemented in the kernel of an operating system and may include receiving at least one request regarding at least one designated device of a plurality of devices from at least one application program. The request is then communicated to the designated device(s) via a well-known communication protocol. Information is then received from the designated device and forwarded to the application program that sent the request. The system may include a processor and a memory coupled to a bus, at least one application program, and a communications server integrated with an operating system. The communication server passes information between the application program and devices using a communication protocol. The communication protocol in the method and system may be the User Datagram Protocol/Internet Protocol (UDP/IP).

### FIELD OF THE INVENTION

The invention relates generally to computer networking, and, more specifically to distributed device control.

### BACKGROUND

Computers are machines that include various devices, whether they be included internally in a computer case, attached in a card cage, or attached externally. In UNIX® operating system based systems, various methods may be used to control and manage devices. An input/output control methodology referred to as ioctls are system calls that enable a user space application to query and control devices that exist in the kernel space. Using ioctls to control devices has various requirements that amount to limitations. When using ioctls, the controlling application must be running on the same host as the controlled device. All ioctls to a particular device are synchronous, and, therefore, there can be only one outstanding ioctl request to a given device. In addition, when using ioctls, the devices cannot initiate communication with a controlling application; communication can only be initiated by application programs.

Another method for accessing and controlling devices in UNIX® operating system based systems is the /proc file system. The /proc file system is a virtual file system accessible from the user space. In the Linux version of the UNIX® operating system, the /proc file system may be used to control and manage kernel devices. In Linux, the /proc file system can also be used by devices to report the status of a particular device and statistics for a particular device to the user space. A particular device may create and own one or more of the virtual files of the /proc file system. In this way, a single virtual file provides only a simplex communication mechanism; that is, more than one file is needed for full duplex communication. The /proc file system also requires that the controlling application be running on the same host as the controlled device. In addition, event notifications initiated by a particular device require the user application to continuously poll the particular virtual file of the /proc file system, thereby defeating the purpose of asynchronous communication.

Yet another method for accessing and controlling devices in Linux operating system based systems are netlink sockets. These are special sockets that only exist in the Linux variant of the UNIX® operating system. Netlink sockets provide asynchronous event notification from the kernel space to the user space. However, just as with ioctls and the /proc file system, when using netlink sockets, the controlling application must be running on the same host as the controlled device.

None of these methods allow for access and control of devices from a remote host.

### BRIEF SUMMARY OF THE INVENTION

The invention described herein involves a system and method for distributed device control. The method may be implemented in the kernel of an operating system and may include receiving at least one request regarding at least one designated device of a plurality of devices from at least one application program. The request is then communicated to the designated device(s) via a well known communication protocol. Information is then received from the designated device and forwarded to the application program that sent the request. The system may include a processor and a memory coupled to a bus, at least one application program, and a communications server integrated with an operating system. The communication server passes information between the application program and devices using a communication protocol. The communication protocol in the method and system may be the User Datagram Protocol/Internet Protocol (UDP/IP).

### BRIEF DESCRIPTION OF THE DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 illustrates a hardware environment in which one embodiment of the invention may execute.

FIG. 2 illustrates a generalized conceptual architecture of one embodiment of the invention.

FIG. 3 illustrates a conceptual architecture of one embodiment of the invention.

FIG. 4 illustrates an environment in which one embodiment of the invention may execute.

FIG. 5 illustrates a flow of actions taken pursuant to one embodiment of the invention.

### DETAILED DESCRIPTION

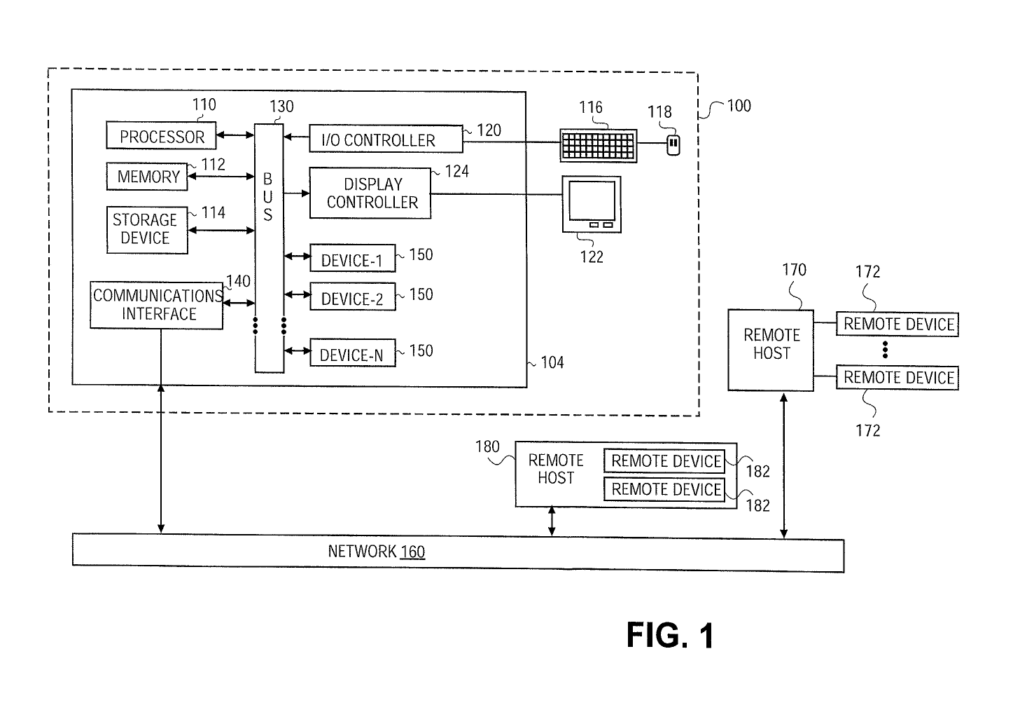

FIG. 1 illustrates a hardware environment in which one embodiment of the invention may execute. System 100 may be a computer system that includes a computing device 104, display monitor 122, and input devices such as a keyboard 116 and mouse 118. The computing device 104 is coupled to a network 160 via communications interface 140. In one embodiment, network 160 is capable of communication using the User Datagram Protocol (UDP) and the Internet Protocol (IP). (For more information on UDP and IP, see J. Postel, User Datagram Protocol, RFC 768, Aug. 28, 1980, http//www.rfc-editor.org/rfc/rfc768.txt and J. Postel, Internet Protocol, RFC 791, September 1981, http://www.rfc-editor.org/rfc/rfc791.txt., incorporated herein by reference.) Computing device 104 may include a processor 110, memory 112, storage device 114, input/output (I/O) controller 120, display controller 124, and one or more other devices 150. In one embodiment, devices 150 may include networking devices such as, for example, modems routers, multiplexors, hubs, and other similar devices. In one embodiment, computing device 104 may include multiple processors.

In one embodiment, some or all of the present methods which individually and/or collectively make up the present invention may be stored as software (i.e., computer readable instructions) on storage device 114 and executed by processor 110 using memory 112. In another embodiment, the method may be stored as hardware or a combination of hardware and software such as firmware. In one embodiment, storage device 114 may be any machine readable medium, where a machine readable medium includes any mechanism that provides (i.e., stores and/or transmits) information in a form readable by a machine (e.g., a computer). For example, a machine readable medium includes read only memory (ROM); random access memory (RAM); magnetic disk storage media such as a hard disk drive or floppy disk drive; optical storage media such as a compact disk read-only memory (CD-ROM) and a readable and writeable compact disk (CD-RW); flash memory devices including stick and card memory devices; electrical, optical, acoustical or other form of propagated signals (e.g., carrier waves, infrared signals, digital signals, etc.); etc. The various components of computing device 104 may be coupled to one another via bus 130. Bus 130 may be any well-known or proprietary bus. In addition, one or more buses may be included in various embodiments (e.g., processor, memory and/or peripheral busses).

In one embodiment, computing device 104 may be a card connected to a back plane and each of devices 150 maybe separate cards connected to the same back plane. In this embodiment, system 100 may be a rack system or a card cage. In one embodiment, bus 130 may be a back plane over which messages are transmitted via the Internet Protocol (IP). In another embodiment, system 100 may include a server computer as computing device 104, and device 150 may be coupled internally and/or externally with computing device 104.

According to the present methods, application programs on one network host may communicate with and control devices both on other, remote network hosts and on local devices resident within the system in which the present methods execute. That is, system 100 may be a host on network 160 and may include an application program on computing device 104 which, via the present methods, communicates with and controls remote devices 182 on remote host 180 and remote devices 172 on remote host 170. Remote hosts 170 and 180 may be similar to system 100 and computing device 104. Input devices and a display monitor may be optionally included on remote hosts 170 and 180. Although the devices 150 shown with regard to computer 104 are illustrated within computing device 104, in various embodiments, the devices 150 may be coupled to bus 130 by an internal back plane, via any standard bus connection, or may be external to computing device 104. That is, system 100 may be, in one embodiment, configured like remote host 180 which includes remote devices 182 internal to remote host 180, and, in another embodiment, like remote host 170 which includes remote devices 172 external to remote host 170. In another embodiment, not shown, system 100 and remote hosts 170 and 180 may have both internal and external devices. In one embodiment, devices 150 and remote devices 172 and 182 are capable of communicating via UDP and IP. In one embodiment, system 100 and remote hosts 170 and 180 may include a well known operating system such as, in one embodiment, Linux. In some embodiments, secure communications may be implemented using the IP Security protocol (IPsec). (For more information on IPsec, see S. Kent et al., Security Architecture for the Internet Protocol, November 1998, http://www.rfc-editor.org/rfc/rfc2401.txt., incorporated herein by reference.)

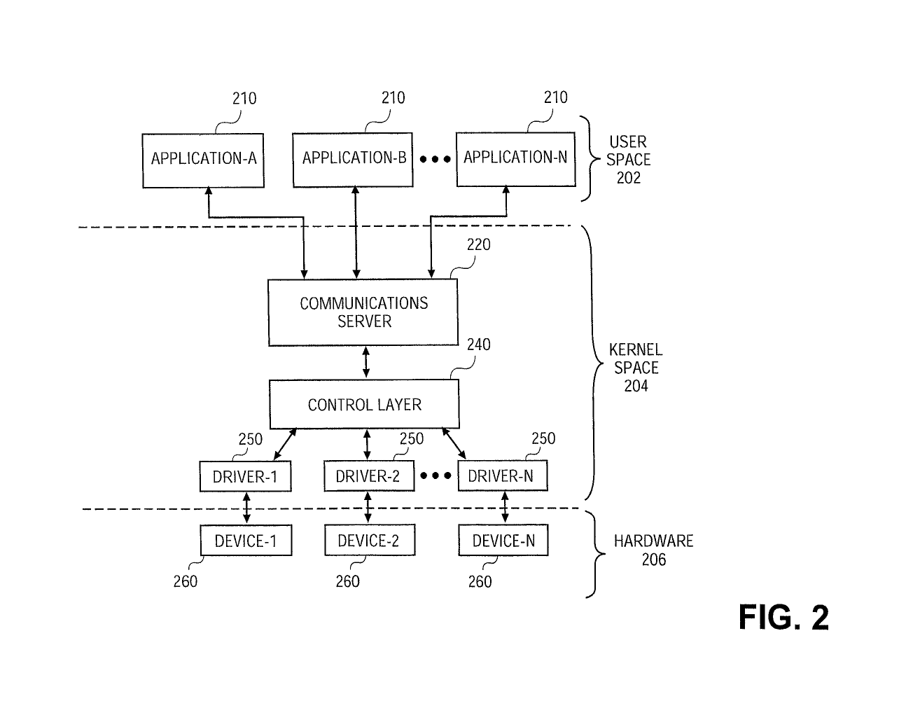

FIG. 2 illustrates a generalized conceptual architecture of one embodiment of the invention. The present methods of the invention may be thought of as residing in the kernel space 204, where the kernel space 204 resides between the user space 202 and hardware 206. The kernel refers to the software of an operating system in the UNIX® family of operating systems and its variants, such as Linux. In one embodiment, the kernel is that of the Linux operating system. In one embodiment, one or more application programs such as applications 210 exist in user space 202. In one embodiment, the application programs 210 may exist on one computing device, computer or system. In another embodiment, application programs may exist on multiple computing devices, computers or systems. The application programs communicate via a well-known communication protocol with a communications server 220 that exists in kernel space 204. The communications server passes information between devices 260 and applications 210. For example, the application programs may send device control requests and status requests to the communications server 220. In one embodiment, a separate control layer 240 provides the capability for the communications server to communicate with each of the drivers 250 which allows for communication with and control of devices 260. In one embodiment, control layer 240 may serve as a multiplexor, taking a single request from the communications server and sending it to multiple devices via multiple device drivers. Similarly, information received from the devices via the device drivers may be demultiplexed in that the information may be combined and forwarded to an application program via the communications server. In another embodiment, control layer 240 may be incorporated as part of or included in communications server 220. In one embodiment, for each device or group of same devices, there is a driver 250 associated with the device.

The application programs provide a high-level interface to and/or high-level access from the user space 202 to the devices 260 at hardware level 206. Communications server 220 allows application programs 210 from user space 202 to access devices 260 at hardware level 206 in a uniform manner so that the applications are not required to conform to the unique communication requirements of each of the drivers 250. This makes distributed communication with and monitoring of local as well as remote devices by application programs easier to achieve.

In addition, communications server 220 allows application programs from the user space on any network host to access devices 260 at the hardware level. For example, referring to FIG. 1 and FIG. 2, in various embodiments, application programs 210 present on remote host 170 may be used to control devices on system 100; application programs 210 present on system 100 may be used to control remote devices on remote hosts such as remote hosts 170 and 180; and application programs 210 present on system 100 may be used to control local devices 150. In various embodiments, the application programs 210 may send control requests to one or more local or remote devices via communications server 220. These control requests may be used for various purposes, such as, for example, to set or change one or more options or features of a designated device, to power up a designated device, to power down a designated device, to restart a designated device, to upgrade software on a designated device, such as a programmable read only memory (PROM) upgrade, firmware upgrade, etc.

In various embodiments, the application programs 210 may send status requests to one or more local or remote devices. In one embodiment, in which the devices, local and/or remote, are network interfaces, the status request may be used to query the local and/or remote devices for network statistics, such as, for example, packets in and out, bytes sent and received, the number of missing packets, the number of erroneous packets, etc. These status requests may be used by some application programs 210 to monitor the status of the device(s) and determine whether to automatically send a communication to or otherwise notify a system administrator, to automatically take load balancing actions, to automatically reconfigure one or more devices, to automatically restart or shut down one or more devices, etc. Other application programs 210 may be user driven and respond to system operator requests for status information such that the user may then issue commands via an application program through the communications server to balance the load on particular devices, to reconfigure one or more devices, to restart or shut down one or more devices, etc.

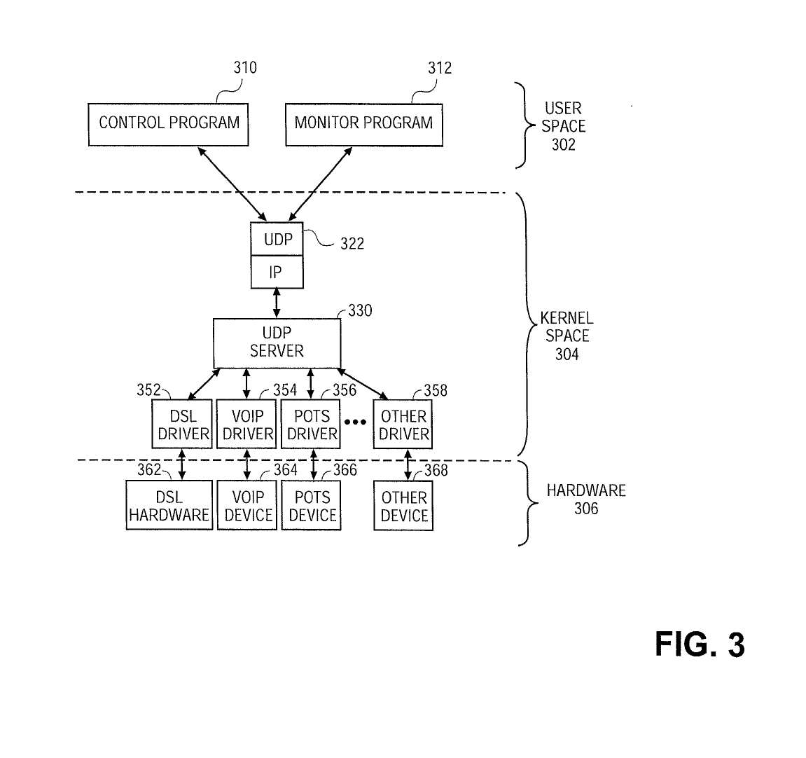

FIG. 3 illustrates a conceptual architecture of one embodiment of the invention. In various embodiments, the application programs may be used to control a particular device or a particular class of devices local and/or remote to the system on which the application program resides, and may be used to monitor a device or monitor a particular class of devices local and/or remote to the system on which the application program resides. In one embodiment, control program 310 may be used to control digital subscriber line (DSL) hardware 362 such as a DSL modem. The DSL modem may support one or more varieties of DSL technology such as, for example, asymmetric DSL (ADSL), symmetric DSL (SDSL) and G.lite. A user may send a control request via control program 310 to DSL hardware 362 to change settings on the DSL modem, to restart the DSL modem, etc. To do so, control program 310 must be written so as to be able to communicate with UDP server 330. In this embodiment, the application programs, such as control program 310 and monitor program 312, communicate with hardware devices such as DSL hardware 362 via the well known UDP/IP protocol through UDP server 330. In one embodiment, this is achieved via UDP/IP queue 322. In this embodiment, UDP/IP queue 322 is used to temporally hold control or monitor program requests which are handled in order by UDP server 330. In one embodiment, UDP server 330 communicates a control request directly to the hardware devices via the appropriate drivers for the particular hardware device. For example, DSL driver 352 is used to control and communicate with DSL hardware 362, voice over IP (VOIP) driver 354 is used to communicate with VOIP device 364, plain old telephone system (POTS) driver 356 is used to communicate with POTS device 366, etc. The number of devices and kinds of devices are not limited. Other devices may include synchronous optical network (SONET) hardware, E1 hardware, T3 hardware, T1 hardware, asynchronous transfer mode (ATM) hardware, very high speed DSL (VDSL) hardware, Gigabit Ethernet hardware, and the like. Further devices may include, for example, fiber optic hardware, satellite transmission hardware, microwave communication hardware, infrared communication hardware, etc.

In one embodiment, the drivers communicate with the UDP server via function calls and the application programs communicate with the UDP server via sockets. In this way, not only can information be passed from application programs through the UDP server to devices, but information can be passed from the devices through the UDP server to the appropriate application program. In one embodiment, one UDP socket is assigned for each POTS device for communication by the UDP server with application programs. In one embodiment, one UDP socket is assigned for all DSL devices such that application programs may communicate with all DSL devices via the one socket with the UDP server. In this embodiment, the UDP server acts as a multiplexor for information passing to multiple DSL devices from a single control application program and as a demultiplexor for information passing from multiple DSL and/or other devices to control and/or monitor application programs. In this embodiment, the control application program may be a specialized DSL control application program, and the monitor application program may be a specialized DSL monitor application program.

In one embodiment, control program 310 and monitor program 312 may exist on one network host, while some or all of the hardware devices are located at a remote host. In this embodiment, each of the remote hosts must include the UDP server described herein. By using the UDP stack 322 in the kernel of the host running the application programs, the application programs can communicate in a well-known manner via UDP to access remote devices via the UDP servers on the remote hosts. This allows for users to monitor and control remote devices on an IP network from their local system.

In other embodiments, the Transmission Control Protocol (TCP) or Stream Control Transmission Protocol (SCTP) may be used in place of UDP. (For more information on TCP and SCTP see T. Socolofsky, A TCP/IP Tutorial, RFC 1180, January 1991, http://www.rfc-editor.org/rfc/rfc1180.txt and R. Stewart et al., Stream Control Transmission Protocol, October 2000, http://www.rfc-editor.org/rfc/rfc2960.txt., incorporated herein by reference.) In all embodiments, the transport layer of the communications protocols (e.g., UDP, TCP, SCTP) on the particular system must reside in the kernel space for the implementation of the invention described herein. The network layer and any other layers on which the transport layer are dependent must, therefore, also exist the kernel space. In addition, in other embodiments, the invention described herein may be implemented on any operating system that provides UDP or similar socket support via the kernel layer. That is, the invention described herein is not limited to UNIX® derived operating systems, but may be used with any operating system that includes a kernel space and a user space, and provides for UDP sockets or similar sockets which can be moved into the kernel of the operating system and used as a communications server.

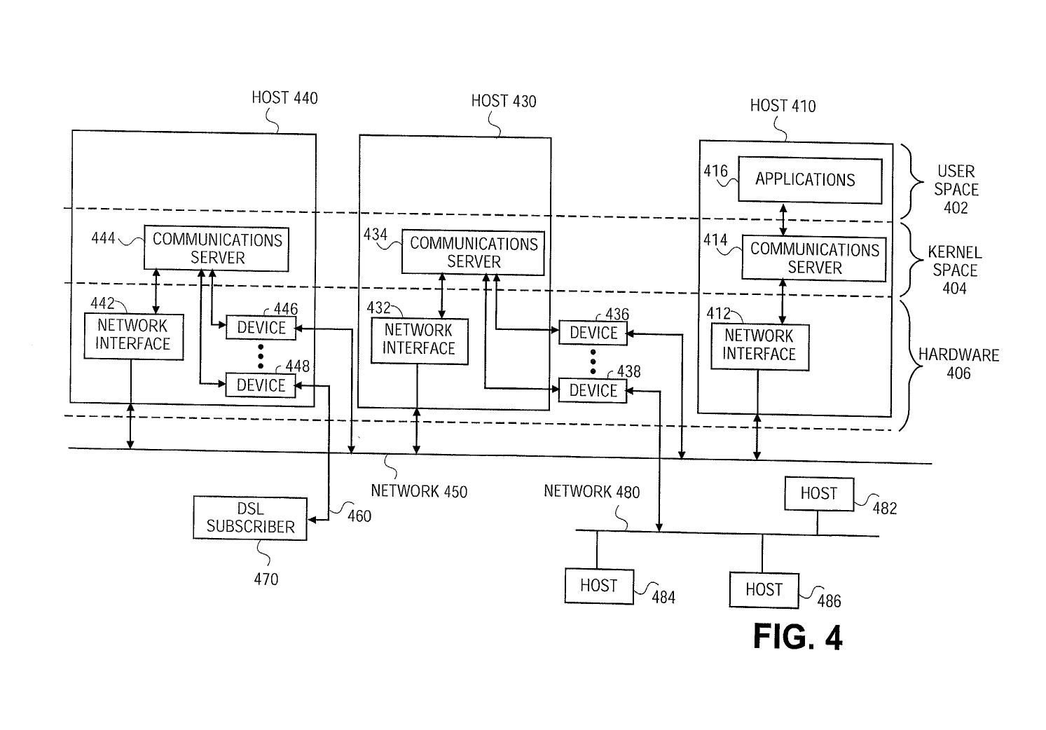

FIG. 4 illustrates an environment in which one embodiment of the invention may execute. As discussed above regarding FIGS. 2 and FIG. 3, application programs such as applications 416 in user space 402 on network host 410 may obtain information about and send information to remote devices 436, 438, 446 and 448 at hardware level 406 on remotes hosts 430 and 440. In this embodiment, a request for information may be sent from user space 402 by application program 416 via communications server 414 in kernel space 404 through network interface 412 to the remote hosts. The request is received by network interfaces 442 and 432 at hardware level 406 and forwarded to communications servers 434 and 444 in kernel space 404. Communications servers 434 and 444 then pass the requested information from the particular remote device or devices 436, 438, 446 and 448 to the requesting applications 416 via communications server 414. A request to set a configuration parameter or to restart or shut down one of remote devices 436, 438, 446 and 448 may be communicated in a similar manner by applications 416. In this embodiment, devices 436, 438, 446 and 448 may provide asynchronous events or status information to subscribing applications 416 via communications servers 434 and 444, respectively, through communications server 414. In addition, applications 416 on host 410 may also access information about and send information to local devices, not shown, via communications server 414.

In one embodiment, various devices, such as devices 446 and 436, may be coupled to the same network on which the application programs reside. In another embodiment, various other devices, such as devices 448 and 438, may be coupled to another network such as network 480 or one or more DSL lines, such as DSL line 460, which connects DSL subscriber 470 to the Internet. In this embodiment, an application program may control and/or monitor the network device providing Internet access to a DSL subscriber. Similarly, an application program may control and/or monitor the status of another network such as network 480 having various hosts, such as hosts 482, 484 and 486. These hosts may be personal computing devices, server computers, and hosts similar to hosts 410, 430 and 440. In this way, other devices on other networks may also provide status information to the application program and the application program may control other devices residing on the other network.

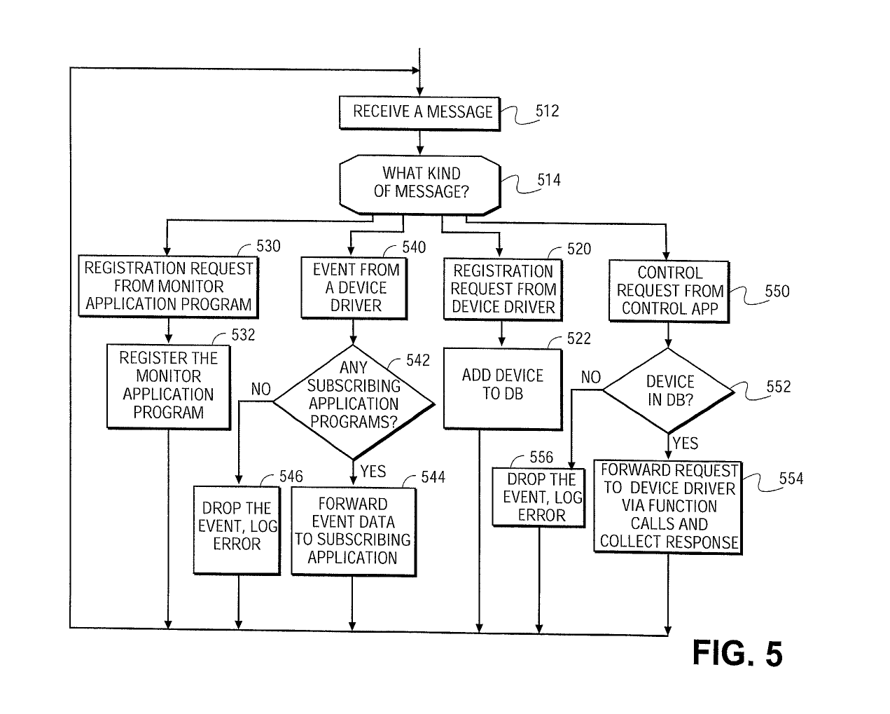

FIG. 5 illustrates a flow of actions taken pursuant to one embodiment of the invention. The communications server, which, in one embodiment, is a UDP server, receives a message, as shown in block 512. In one embodiment, the message may contain various fields that are in attribute, value, length format. In one embodiment, the message contains a message type and the particular data relevant to that message type. The message type then determines what next occurs. In one embodiment, messages are received and then processed sequentially in the order in which they are received. The message is analyzed, and the kind of message is determined, as shown in block 514. If the message is a registration request from a device driver, then the device is registered by adding a device driver identifier to a database, as shown in block 522. In one embodiment, a function call identifier may be included in the registration request such that the function call identifier is also added to the database to be used for future communication with the driver. If the message is a registration request from a monitor application program, as shown in block 530, then the communications server registers the monitor application program, as shown in block 532. In this way, a monitor application program may subscribe to events from a specified device, device class, or group of devices.

If the message is an event from a device received via a device driver, as shown in block 540, a check is then made to determine whether any subscribing application programs have registered for the event, as shown in block 542. In one embodiment, this is achieved by reviewing the database. If one or more monitor application programs subscribed to the event and/or the device, then the event data is forwarded to those subscribing monitor application programs, as shown in block 544. If there are no monitor application programs subscribing to the event, the event is dropped and an error is logged, as shown in block 546. In one embodiment, an error handler application program may periodically check the error log and display these and other errors to a user of the system via a graphical user interface.

If the message is a control request from a control application program specifying one or more devices or kinds of devices, as shown in block 550, a check is made to determine whether the device is accessible by the communications server, as shown in block 552. In one embodiment, this is achieved by checking the database. In one embodiment, the control request may be a status request for information concerning a particular device, a particular class of devices, or all devices. In another embodiment, the control request may be a command to one or more of the devices to change or otherwise update one or more specified settings, to restart, to shut down, etc. If the specified device or devices are accessible via the communications server, the control request is forwarded to the specified device(s) via the appropriate device driver(s) via an appropriate socket, as shown in block 554. In one embodiment, a response to the control request, if any, may be collected and returned to the requesting application program(s). If the device specified in the control request is not accessible via the communications server, then the request is dropped and an error is logged, as shown in block 556. In one embodiment, an error handler application program may periodically check the error log and display these and other errors to a user of the system via a graphical user interface.

In another embodiment, the communications server may receive a delete socket request from a monitor application program. This results in the unsubscription of the monitor application program from events from a device. The database is updated accordingly. This typically occurs when the monitor application program is shutting down. In addition, in another embodiment, the communications server may also receive a device unregistration request which causes the communications server to remove the particular device from its database.

Although not shown, in one embodiment, the communications server may also receive a control layer unregistration request which causes the communications server to remove all devices from its database.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method in the kernel of an operating system comprising:
receiving in the kernel of an operating system at least one request regarding at least one designated device of a plurality of devices from at least one application program;
communicating the at least one request from the kernel of the operating system to the at least one designated device via a well known communication protocol;
receiving in the kernel of the operating system information from the at least one designated device; and
forwarding the information from the kernel of the operating system to the application program that sent the request.

2. The method of claim 1 wherein the at least one designated device comprises a remote device accessible via a network.

3. The method of claim 2 wherein the at least one designated device comprises a local device.

4. The method of claim 1 wherein the at least one request comprises at least one of a status request and a control request.

5. The method of claim 1 wherein the communications protocol is the user datagram protocol (UDP).

6. The method of claim 1 wherein receiving the request is achieved via at least one socket.

7. The method of claim 1 further comprising:
receiving in the kernel of the operating system a subscription request from an application program regarding at least one of the plurality of devices;
receiving in the kernel of the operating system an event from one of the plurality of devices; and
forwarding event information from the kernel of the operating system to the application program that sent the subscription request regarding the device.

8. The method of claim 1 wherein forwarding the information is achieved via a socket.

9. A system comprising:
a processor and a memory coupled to a bus;
at least one application program;
a communications server to pass information between the at least one application program and at least one of a plurality of devices via a communication protocol, the communications server integrated within a kernel of an operating system.

10. The system of claim 9 wherein the plurality of devices comprise at least one of:
a plurality of local devices; and
a plurality of remote devices accessible via a network.

11. The system of claim 9 wherein the communication protocol is the user datagram protocol/internet protocol (UDP/IP) such that the communication server is a user datagram protocol (UDP) server.

12. The system of claim 9 wherein the information passed from the at least one application program to the at least one device comprises at least one of a status request and a control request.

13. The system of claim 9 wherein the application program is coupled to the communication server via a socket.

14. The system of claim 9 wherein the application program is coupled to the communication server via a queue.

15. A machine readable medium having stored thereon instructions which when executed by a processor cause a machine to perform operations comprising:
receiving in the kernel of an operating system at least one request regarding at least one designated device of a plurality of devices from at least one application program;
communicating the at least one request from the kernel of the operating system to the at least one designated device via a well known communication protocol;
receiving in the kernel of the operating system information from the at least one designated device; and
forwarding the information from the kernel of the operating system to the application program that sent the request.

16. The machine readable medium of claim 15 wherein the at least one designated device comprises a remote device accessible via a network.

17. The machine readable medium of claim 15 wherein the at least one designated device comprises a local device.

18. The machine readable medium of claim 15 wherein the at least one request comprises at least one of a status request and a control request.

19. The machine readable medium of claim 15 wherein the communications protocol is the user datagram protocol/internet protocol (UDP/IP).

20. The machine readable medium of claim 15 wherein receiving the request is achieved via at least one socket.

21. The machine readable medium of claim 15, wherein the instructions cause the machine to perform operations further comprising:
receiving in the kernel of the operating system a subscription request from an application program regarding at least one of the plurality of devices;
receiving in the kernel of the operating system an event from one of the plurality of devices; and
forwarding event information from the kernel of the operating system to the application program that sent the subscription request regarding the device.

22. The machine readable medium of claim 15 wherein forwarding information is achieved via a socket.

23. The machine readable medium of claim 15 wherein the operating system is the Linux operating system.
